(19) United States
(12) Patent Application Publication
(10) Pub. No.: US 2026/0193122 A1
(43) Pub. Date: Jul. 9, 2026

(54) METHODS FOR MANUFACTURING A GLASS RIBBON

(71) Applicant: CORNING INCORPORATED, CORNING, NY (US)

(72) Inventors: Tomohiro Aburada, Painted Post, NY (US); Chih Wei Huang, Taichung (TW); Xinghua Li, Horseheads, NY (US); Michael Yoshiya Nishimoto, Horseheads, NY (US); Gaozhu Peng, Horseheads, NY (US)

(21) Appl. No.: 19/132,112

(22) PCT Filed: Dec. 7, 2023
(86) PCT No.: PCT/US2023/082800

§ 371 Date: May 22, 2025

Related U.S. Application Data
(60) Provisional application No. 63/432,753, filed on Dec. 15, 2022.

(51) Int. Cl. C03B 17/06

(52) U.S. Cl. CPC C03B 17/067; C03B 17/064

(57) ABSTRACT

Methods of manufacturing glass include determining a first location of a first region from a sample of a glass ribbon. The first region includes a first stress outside of a predetermined stress range. Methods include determining a second location of a second region from the glass ribbon based on the first location from the sample. The second region includes a second stress outside the predetermined stress range. Methods include heating the second region by irradiating the second region with a laser beam while the glass ribbon travels along a ribbon travel path such that the second region is heated from a first temperature, which is greater than or equal to a transition temperature of the glass ribbon, to a second temperature. Methods include cooling the second region from the second temperature such that the second region comprises a third stress within the predetermined stress range.

### CROSS-REFERENCE TO RELATED APPLICATIONS

This application claims the benefit of priority under 35 U.S.C. § 119 of U.S. Provisional Application Ser. No. 63/432,753 filed on Dec. 15, 2022, the content of which is relied upon and incorporated herein by reference in its entirety.

### FIELD

The present disclosure relates generally to apparatus and methods for manufacturing a glass ribbon and, more particularly, to methods for manufacturing a glass ribbon with a laser beam.

### BACKGROUND

It is known to manufacture a glass ribbon with a glass manufacturing device. Conventional forming devices are known to operate to down draw a quantity of molten material from the glass ribbon forming device as the glass ribbon. However, areas of the glass ribbon can experience stress that is outside of a predetermined stress range. Excess stress is undesirable and can reduce the quality of the glass ribbon. Further, treating the entire glass ribbon is not cost effective when only one area of the glass ribbon experiences stress that is outside of the predetermined stress range.

### SUMMARY

The following presents a simplified summary of the disclosure to provide a basic understanding of some aspects described in the detailed description.

There are set forth methods of manufacturing glass with a laser beam. For example, a glass ribbon can travel along a ribbon travel path in a ribbon travel direction. One or more areas of the glass ribbon can comprise a stress that is outside of a desired predetermined stress range. Rather than treat the entire glass ribbon to alter the stress, a laser beam can be used to locally heat the area of the glass ribbon comprising the stress that is outside of the desired predetermined stress range. Further, the laser beam can impinge upon the glass ribbon at a time when the glass ribbon is within a fusion machine and at an elevated temperature. As such, the amount of power needed to heat the area of the glass ribbon with the laser beam is limited, and the stress within the glass ribbon can be locally adjusted.

In aspects, methods of manufacturing glass can comprise determining a first location of a first region from a sample of a glass ribbon. The first region can comprise a first stress outside of a predetermined stress range. Methods can comprise determining a second location of a second region from the glass ribbon based on the first location from the sample. The second region can comprise a second stress outside of the predetermined stress range. Methods can comprise heating the second region of the glass ribbon by irradiating the second region with a laser beam while the glass ribbon travels along a ribbon travel path in a ribbon travel direction such that the second region can be heated from a first temperature, which is greater than or equal to a transition temperature of the glass ribbon, to a second temperature. Methods can comprise cooling the second region from the second temperature such that the second region can comprise a third stress within the predetermined stress range.

In aspects, the second region can comprise a first viscosity prior to heating with the laser beam and a second viscosity after heating with the laser beam, and a difference between the first viscosity and the second viscosity can be less than about 1×10¹² poise.

In aspects, a difference between the first temperature and the second temperature can be less than about 10° C.

In aspects, the second region can comprise a first fictive temperature prior to heating with the laser beam and a second fictive temperature after heating with the laser beam. The second fictive temperature can be different than the first fictive temperature.

In aspects, determining the first location can comprise measuring one or more of a first distance between the first region and a first edge of the sample or a second distance between the first region and an opposing second edge of the sample.

In aspects, determining the second location can comprise locating one or more of the first distance from a first edge of the glass ribbon or the second distance from an opposing second edge of the glass ribbon.

In aspects, heating the second region can comprise setting a wavelength of the laser beam irradiating the second region based on a difference between the second stress and the third stress.

In aspects, heating the second region can comprise setting a power of the laser beam irradiating the second region based on a difference between the second stress and the third stress.

In aspects, methods can comprise moving the laser beam relative to the glass ribbon in a first laser travel direction along the ribbon travel path in the ribbon travel direction.

In aspects, methods can comprise moving the laser beam relative to the glass ribbon in a second laser travel direction across the ribbon travel path perpendicular to the ribbon travel direction.

In aspects, methods of manufacturing glass can comprise heating a region of a glass ribbon comprising a first stress outside of a predetermined stress range by irradiating the region with a laser beam as the glass ribbon moves along a ribbon travel path in a ribbon travel direction such that the region is heated from a first temperature greater than or equal to a transition temperature of the glass ribbon to a second temperature. The region can comprise a first viscosity prior to heating with the laser beam and a second viscosity after heating with the laser beam such that a difference between the first viscosity and the second viscosity is less than about 1×10¹² poise and a difference between the first temperature and the second temperature is less than about 10° C. Methods can comprise cooling the region from the second temperature such that the region comprises a second stress within the predetermined stress range.

In aspects, the region can comprise a first fictive temperature prior to heating with the laser beam and a second fictive temperature after heating with the laser beam. The second fictive temperature can be different than the first fictive temperature.

In aspects, heating the region can comprise setting a wavelength of the laser beam irradiating the region based on a difference between the first stress and the second stress.

In aspects, heating the region can comprise setting a power of the laser beam irradiating the region based on a difference between the first stress and the second stress.

In aspects, methods can comprise moving the laser beam relative to the glass ribbon in a first laser travel direction along the ribbon travel path in the ribbon travel direction.

In aspects, methods can comprise moving the laser beam relative to the glass ribbon in a second laser travel direction across the ribbon travel path perpendicular to the ribbon travel direction.

In aspects, methods can comprise determining a first location of a first region from a sample of the glass ribbon. The first region can comprise a first stress outside of the predetermined stress range. Determining the first location can comprise measuring one or more of a first distance between the first region and a first edge of the sample or a second distance between the first region and an opposing second edge of the sample.

In aspects, prior to heating the region, methods can comprise determining a location of the region based on the first location from the sample.

Additional features and advantages of the aspects disclosed herein will be set forth in the detailed description that follows, and in part will be clear to those skilled in the art from that description or recognized by practicing the aspects described herein, including the detailed description which follows, the claims, as well as the appended drawings. It is to be understood that both the foregoing general description and the following detailed description present aspects intended to provide an overview or framework for understanding the nature and character of the aspects disclosed herein. The accompanying drawings are included to provide further understanding and are incorporated into and constitute a part of this specification. The drawings illustrate various aspects of the disclosure, and together with the description explain the principles and operations thereof.

### BRIEF DESCRIPTION OF THE DRAWINGS

These and other features, aspects and advantages are better understood when the following detailed description is read with reference to the accompanying drawings, in which:

FIG. 1 schematically illustrates example aspects of a glass manufacturing apparatus in accordance with aspects of the disclosure;

FIG. 2 illustrates a perspective cross-sectional view of the glass manufacturing apparatus along lines 2-2 of FIG. 1 in accordance with aspects of the disclosure;

FIG. 3 illustrates a perspective view of a sample of a glass ribbon comprising a first region with a first stress outside of a predetermined stress range in accordance with aspects of the disclosure;

FIG. 4 illustrates a perspective view of a sample of a glass ribbon comprising a first region with a first stress outside of a predetermined stress range in accordance with aspects of the disclosure;

FIG. 5 illustrates a perspective view of the glass ribbon comprising a second region with a second stress outside of a predetermined stress range in accordance with aspects of the disclosure; and

FIG. 6 illustrates a perspective view of a laser irradiating the second region of the glass ribbon in accordance with aspects of the disclosure.

### DETAILED DESCRIPTION

Aspects will now be described more fully hereinafter with reference to the accompanying drawings in which example aspects are shown. Whenever possible, the same reference numerals are used throughout the drawings to refer to the same or like parts. However, this disclosure may be embodied in many different forms and should not be construed as limited to the aspects set forth herein.

As used herein, the term “about” means that amounts, sizes, formulations, parameters, and other quantities and characteristics are not, and need not be, exact, but may be approximate and/or larger or smaller, as desired, reflecting tolerances, conversion factors, rounding off, measurement error and the like, and other factors known to those of skill in the art.

Ranges can be expressed herein as from “about” one value, and/or to “about” another value. When such a range is expressed, aspects include from the one value to the other value. Similarly, when values are expressed as approximations by use of the antecedent “about,” it will be understood that the value forms another aspect. It will be further understood that the endpoints of each of the ranges are significant both in relation to the other endpoint, and independently of the other endpoint.

Directional terms as used herein—for example up, down, right, left, front, back, top, bottom, upper, lower, etc. —are made only with reference to the figures as drawn and are not intended to imply absolute orientation.

Unless otherwise expressly stated, it is in no way intended that any methods set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including matters of logic relative to arrangement of steps, operational flow, order of components, or orientation of components; plain meaning derived from grammatical organization or punctuation, and; the number or type of aspects described in the specification.

As used herein, the singular forms “a,” “an” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including”, and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to represent that a described feature is equal or approximately equal to a value or description. For example, a “substantially planar” surface is intended to denote a surface that is planar or approximately planar. Moreover, “substantially” is intended to denote that two values are equal or approximately equal. The term “substantially” may denote values within about 10% of each other, for example, within about 5% of each other, or within about 2% of each other.

Modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first end and a second end generally correspond to end A and end B or two different ends.

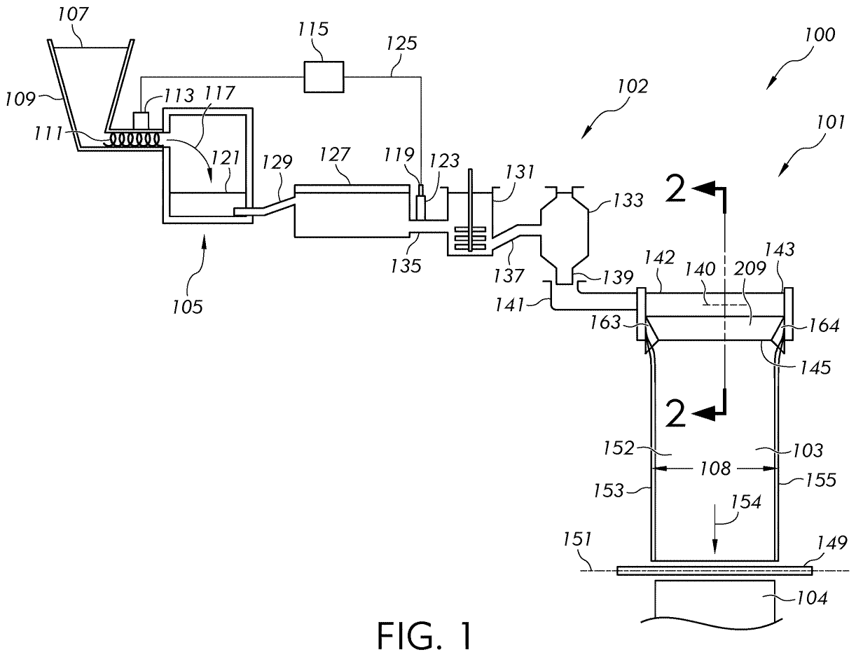

The present disclosure relates to a glass manufacturing apparatus and methods for producing a glass ribbon. For purposes of this application, “ribbon” may be considered one or more of a glass ribbon in a viscous state, a glass ribbon in an elastic state (e.g., at room temperature) and/or a glass ribbon in a viscoelastic state between the viscous state and the elastic state. The glass ribbon may comprise a glass ribbon of an indeterminate length or one or more separated glass articles (e.g., separated ribbons, separated sheets, etc.) that comprise multiple, e.g., four, discrete edges. Methods and apparatus for manufacturing a glass ribbon will now be described by way of example aspects. As schematically illustrated in FIG. 1, an exemplary glass manufacturing apparatus 100 can comprise a glass melting and delivery apparatus 102 and a forming device 101 designed to produce a glass ribbon 103 from a quantity of molten material 121. The glass ribbon 103 can comprise a central portion 152 positioned between opposite edge portions (e.g., edge beads) formed along a first edge 153 and a second edge 155 of the glass ribbon 103, wherein a thickness of the edge portions can be greater than a thickness of the central portion. Additionally, a separated glass ribbon 104 can be separated from the glass ribbon 103 along a separation path 151 by a glass separator 149 (e.g., scribe, score wheel, diamond tip, laser, etc.).

In aspects, the glass melting and delivery apparatus 102 can comprise a melting vessel 105 oriented to receive batch material 107 from a storage bin 109. The batch material 107 can be introduced by a batch delivery device 111 powered by a motor 113. An optional controller 115 can be operated to activate the motor 113 to introduce a desired amount of batch material 107 into the melting vessel 105, as indicated by arrow 117. The melting vessel 105 can heat the batch material 107 to provide molten material 121. A melt probe 119 can be employed to measure a level of molten material 121 within a standpipe 123 and communicate the measured information to the controller 115 by way of a communication line 125.

Additionally, in aspects, the glass melting and delivery apparatus 102 can comprise a first conditioning station comprising a fining vessel 127 located downstream from the melting vessel 105 and coupled to the melting vessel 105 by way of a first connecting conduit 129. For example, molten material 121 can be gravity fed from the melting vessel 105 to the fining vessel 127 by way of an interior pathway of the first connecting conduit 129. Additionally, bubbles can be removed from the molten material 121 within the fining vessel 127 by various techniques.

In aspects, the glass melting and delivery apparatus 102 can further comprise a second conditioning station comprising a mixing chamber 131 that can be located downstream from the fining vessel 127. The mixing chamber 131 can be employed to provide a homogenous composition of molten material 121, thereby reducing or eliminating inhomogeneity that may otherwise exist within the molten material 121 exiting the fining vessel 127. As shown, the fining vessel 127 can be coupled to the mixing chamber 131 by way of a second connecting conduit 135. For example, molten material 121 can be gravity fed from the fining vessel 127 to the mixing chamber 131 by way of an interior pathway of the second connecting conduit 135.

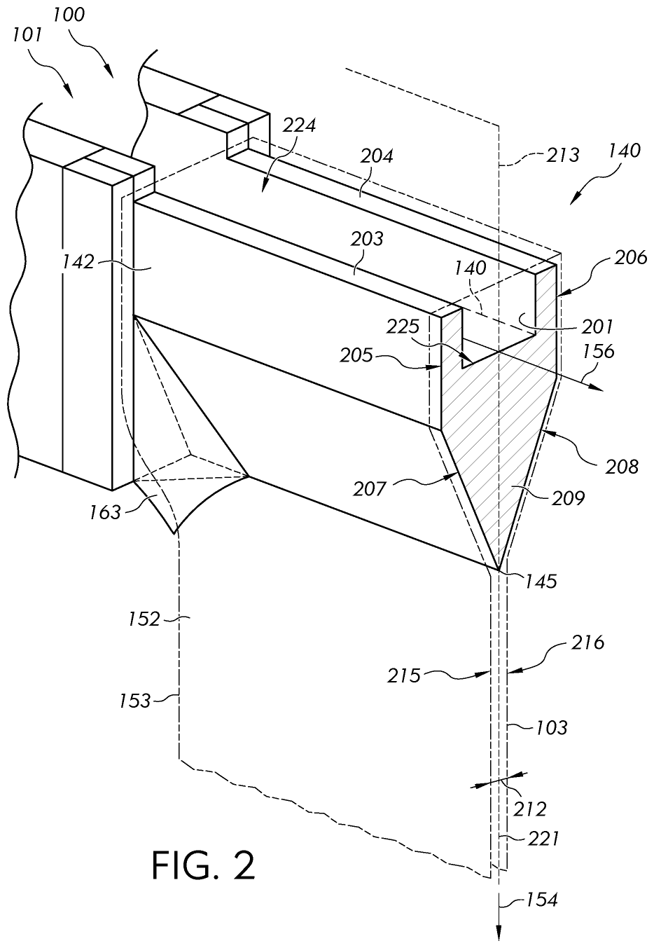

Additionally, in aspects, the glass melting and delivery apparatus 102 can comprise a third conditioning station comprising a delivery chamber 133 that can be located downstream from the mixing chamber 131. The delivery chamber 133 can condition the molten material 121 to be fed into an inlet conduit 141. For example, the delivery chamber 133 can function as an accumulator and/or flow controller to adjust and provide a consistent flow of molten material 121 to the inlet conduit 141. As shown, the mixing chamber 131 can be coupled to the delivery chamber 133 by way of a third connecting conduit 137. For example, molten material 121 can be gravity fed from the mixing chamber 131 to the delivery chamber 133 by way of an interior pathway of the third connecting conduit 137. As further illustrated, a delivery pipe 139 can be positioned to deliver molten material 121 to forming device 101, for example the inlet conduit 141 of the forming device 101. The forming device 101 can comprise a trough (e.g., trough 201 illustrated in FIG. 2) extending along a trough axis 140 between an inlet end 142 and an opposing end 143 of the forming device 101 opposite the inlet end 142. The inlet end 142 is the end of the trough 201 in proximity to the inlet conduit 141 through which the molten material 121 is received. The opposing end 143 is the end farthest from the inlet conduit 141.

By way of illustration, the forming device 101 shown and disclosed below can be provided to fusion draw molten material 121 off a bottom edge, defined as a root 145, of a forming wedge 209 to produce the glass ribbon 103. For example, the molten material 121 can be delivered from the inlet conduit 141 to the forming device 101. The molten material 121 can then be formed into the glass ribbon 103 based, in part, on the structure of the forming device 101. For example, as shown, the molten material 121 can be drawn off the bottom edge (e.g., root 145) of the forming device 101 along a draw path extending in a ribbon travel direction 154 of the glass manufacturing apparatus 100. In aspects, edge directors 163, 164 can direct the molten material 121 off the forming device 101 and define, in part, a width 108 of the glass ribbon 103. The width 108 of the glass ribbon 103 extends between the first edge 153 of the glass ribbon 103 and the second edge 155 of the glass ribbon 103.

In aspects, the width 108 of the glass ribbon 103, which extends between the first edge 153 of the glass ribbon 103 and the second edge 155 of the glass ribbon 103, can be greater than or equal to about 20 millimeters (mm), for example, greater than or equal to about 50 mm, for example, greater than or equal to about 100 mm, for example, greater than or equal to about 500 mm, for example, greater than or equal to about 1000 mm, for example, greater than or equal to about 2000 mm, for example, greater than or equal to about 3000 mm, for example, greater than or equal to about 4000 mm, although other widths less than or greater than the widths mentioned above can be provided in aspects. For example, the width 108 can be within a range from about 20 mm to about 4000 mm, for example, within a range from about 50 mm to about 4000 mm, for example, within a range from about 100 mm to about 4000 mm, for example, within a range from about 500 mm to about 4000 mm, for example, within a range from about 1000 mm to about 4000 mm, for example, within a range from about 2000 mm to about 4000 mm, for example, within a range from about 3000 mm to about 4000 mm, for example, within a range from about 20 mm to about 3000 mm, for example, within a range from about 50 mm to about 3000 mm, for example, within a range from about 100 mm to about 3000 mm, for example, within a range from about 500 mm to about 3000 mm, for example, within a range from about 1000 mm to about 3000 mm, for example, within a range from about 2000 mm to about 3000 mm, for example, within a range from about 2000 mm to about 2500 mm, and all ranges and subranges therebetween.

FIG. 2 shows a cross-sectional perspective view of the forming device 101 along line 2-2 of FIG. 1. In aspects, the forming device 101 can comprise a trough 201 oriented to receive the molten material 121 from the inlet conduit 141. For illustrative purposes, cross-hatching of the molten material 121 is removed from FIG. 2 for clarity. The forming device 101 comprises a pair of weirs 203, 204 defining an opening 224 in the trough 201. The forming device 101 comprises a bottom surface 225, which may be substantially planar, and may extend at least partially between the inlet end 142 and the opposing end 143 (e.g., illustrated in FIG. 1). The bottom surface 225 can at least partially define the trough 201, for example, with the bottom surface 225 extending along a bottom of the trough 201 and the pair of weirs 203, 204 extending along opposing sides of the trough 201. The bottom surface 225 can be substantially planar and may form a right angle with the pair of weirs 203, 204. The bottom surface 225 can comprise opposing edges that extend along the trough axis 140, with the opposing edges contacting the pair of weirs 203, 204. In aspects, the opposing edges can form a rounded shape with the pair of weirs 203, 204, such that the intersection between the bottom surface 225 and the pair of weirs 203, 204 (e.g., at the opposing edges) comprises a radius of curvature. The forming device 101 can further comprise the forming wedge 209 comprising a pair of downwardly inclined converging surface portions 207, 208 extending between opposed ends of the forming wedge 209. The pair of downwardly inclined converging surface portions 207, 208 of the forming wedge 209 can converge along the ribbon travel direction 154 to intersect along the root 145 (e.g., a bottom edge of the forming wedge 209 where the converging surface portions 207, 208 meet) of the forming device 101. A draw plane 213 of the glass manufacturing apparatus 100 can extend through the root 145 along the ribbon travel direction 154, wherein the glass ribbon 103 can be drawn in the ribbon travel direction 154 along the draw plane 213. As shown, the draw plane 213 can bisect the forming wedge 209 through the root 145 although, the draw plane 213 can extend at other orientations relative to the root 145. In aspects, the glass ribbon 103 can move along a ribbon travel path 221 that may be co-planar with the draw plane 213 in the ribbon travel direction 154.

Additionally, the molten material 121 can flow in a flow direction 156 into and along the trough 201 of the forming device 101. The molten material 121 can then overflow from the trough 201 by flowing over corresponding weirs 203, 204, through the opening 224, and downwardly over the outer surfaces 205, 206 of the corresponding weirs 203, 204. Respective streams of molten material 121 can then flow along the downwardly inclined converging surface portions 207, 208 of the forming wedge 209 and be drawn off the root 145 of the forming device 101, where the flows converge and fuse into the glass ribbon 103. The glass ribbon 103 can then be drawn along the ribbon travel direction 154. In aspects, the glass ribbon 103 comprises one or more states of material based on a vertical location of the glass ribbon 103, i.e., distance from the root 145. For example, at a first location, the glass ribbon 103 can comprise the viscous molten material 121, and at a second location, the glass ribbon 103 can comprise an amorphous solid in a glassy state (e.g., a glass ribbon).

The glass ribbon 103 comprises a first major surface 215 and a second major surface 216 facing opposite directions and defining a thickness 212 (e.g., average thickness) of the glass ribbon 103 therebetween. In aspects, the thickness 212 of the glass ribbon 103 can be less than or equal to about 2 millimeters (mm), less than or equal to about 1 millimeter, less than or equal to about 0.5 millimeters, for example, less than or equal to about 300 micrometers (μm), less than or equal to about 200 micrometers, or less than or equal to about 100 micrometers, although other thicknesses may be provided in further aspects. For example, the thickness 212 of the glass ribbon 103 can be within a range from about 20 micrometers to about 200 micrometers, within a range from about 50 micrometers to about 750 micrometers, within a range from about 100 micrometers to about 700 micrometers, within a range from about 200 micrometers to about 600 micrometers, within a range from about 300 micrometers to about 500 micrometers, within a range from about 50 micrometers to about 500 micrometers, within a range from about 50 micrometers to about 700 micrometers, within a range from about 50 micrometers to about 600 micrometers, within a range from about 50 micrometers to about 500 micrometers, within a range from about 50 micrometers to about 400 micrometers, within a range from about 50 micrometers to about 300 micrometers, within a range from about 50 micrometers to about 200 micrometers, within a range from about 50 micrometers to about 100 micrometers, within a range from about 25 micrometers to about 125 micrometers, comprising all ranges and subranges of thicknesses therebetween. In addition, the glass ribbon 103 can comprise a variety of compositions, for example, one or more of soda-lime glass, borosilicate glass, alumino-borosilicate glass, alkali-containing glass, alkali-free glass, aluminosilicate, borosilicate, boroaluminosilicate, silicate, glass-ceramic, or other materials comprising glass. In aspects, the glass ribbon 103 can comprise one or more of lithium fluoride (LiF), magnesium fluoride (MgF₂), calcium fluoride (CaF₂), barium fluoride (BaF₂), sapphire (Al₂O₃), zinc selenide (ZnSe), germanium (Ge) or other materials.

The glass separator 149 (see FIG. 1) can separate the glass ribbon 104 from the glass ribbon 103 along the separation path 151 to provide a plurality of separated glass ribbons 104 (i.e., a plurality of sheets of glass). In aspects, a longer portion of the glass ribbon 104 may be coiled onto a storage roll. The separated glass ribbon can then be processed into a desired application, e.g., a display application. For example, the separated glass ribbon can be used in a wide range of display and non-display applications comprising, but not limited to, liquid crystal displays (LCDs), electrophoretic displays (EPD), organic light emitting diode displays (OLEDs), plasma display panels (PDPs), microLED displays, miniLED displays, organic light emitting diode lighting, light emitting diode lighting, augmented reality (AR), virtual reality (VR), touch sensors, photovoltaics, foldable phones, or other applications.

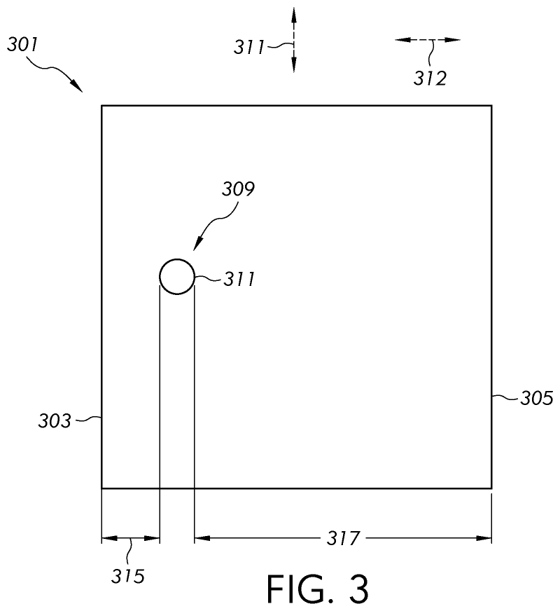

FIG. 3 illustrates a sample 301 of the glass ribbon 103 after the sample 301 has been separated by the glass separator 149. After separation, the sample 301 can be cooled and may comprise one or more discrete edges, such that the sample 301 may comprise a separated glass ribbon 104. For example, the sample 301 can comprise a first edge 303 and an opposing second edge 305 with the first edge 303 substantially parallel to the second edge 305. In aspects, the first edge 303 can match a position of the first edge 153 (e.g., illustrated in FIG. 1) of the glass ribbon 103 and the second edge 305 can match a position of the second edge 155 of the glass ribbon 103. Accordingly, prior to separation by the glass separator 149, the first edges 153, 303 may be attached, continuous and extending coaxially, and the second edges 305, 155 may be attached, continuous, and extending coaxially.

In aspects, methods of manufacturing glass can comprise determining a first location 309 of a first region 311 from the sample 301 of the glass ribbon 103, with the first region 311 comprising a first stress outside of a predetermined stress range. For example, determining the first location 309 of the first region 311 can initially comprise analyzing the sample 301 to obtain a stress profile throughout the sample 301. The stress profile can comprise stress values at a plurality of locations within the sample 301, with peaks and valleys of stress. In aspects, the stress profile can be obtained in several ways, for example, by non-destructively passing light (e.g., a laser beam) through the sample 301 and, based on a detection of the degree of scattered light, determining a stress at specific locations. The stress profile can comprise a plurality of stresses of the sample 301 at locations along a first axis 311, which is parallel to the first edge 303 and the second edge 305 and may be along the ribbon travel direction 154 (e.g., illustrated in FIG. 1), and at locations along a second axis 312, which is perpendicular to the first edge 303 and the second edge 305 and may be perpendicular to the ribbon travel direction 154 (e.g., illustrated in FIG. 1) and the first axis 311. A predetermined stress range can be determined for the sample 301, with the predetermined stress range based on one or more factors such as, for example, the glass composition, the dimensions of the glass, the use or application of the glass, etc. Zero or more locations of the sample 301 may comprise stress peaks or valleys, that is, locations at which the stress is greater than or less than the predetermined stress range.

In aspects, based on the stress profile, zero or more locations of the sample 301 can be determined to comprise stress regions outside of the predetermined stress range. For example, as illustrated in FIG. 3, the first region 311 can comprise a first stress that is outside (e.g., greater than or less than) the predetermined stress range. Determining the first location 309 can comprise measuring one or more of a first distance 315 between the first region 311 and the first edge 303 of the sample 301 or a second distance 317 between the first region 311 and the opposing second edge 305 of the sample 301. Additional distances can be obtained, for example, distances between the first region 311 and other edges of the sample 301. While FIG. 3 illustrates one region comprising a stress outside of the predetermined stress range, the sample 301 may comprise additional regions with stresses outside of the predetermined stress range.

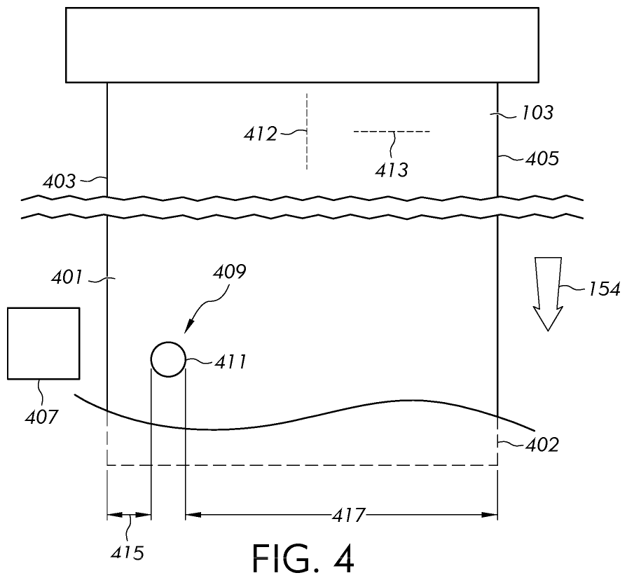

FIG. 4 illustrates a sample 401 of the glass ribbon 103 prior to the sample 401 being separated by the glass separator 149. In this way, the sample 401 may remain attached to and part of the glass ribbon 103 such that the sample 401 can move along a travel path 402 in the ribbon travel direction 154. The sample 401 may comprise a first edge 403 (e.g., substantially matching a position of the first edge 153 illustrated in FIG. 1) and an opposing second edge 405 (e.g., substantially matching a position of the second edge 155). Determining a first location of a first region of a sample is not limited to analyzing a sample 301 from a separated glass ribbon 104 (e.g., illustrated in FIG. 3). Rather, in aspects and as illustrated in FIG. 4, determining a first location of a first region of a sample can occur prior to separation of the sample and while the sample is part of the glass ribbon 103 and moving in the ribbon travel direction 154.

In aspects, methods of manufacturing glass can comprise determining a first location 409 of a first region 411 from the sample 401 of the glass ribbon 103, with the first region 411 comprising a first stress outside of a predetermined stress range. For example, determining the first location 409 of the first region 411 can comprise analyzing the sample 401 (e.g., while the sample 401 remains attached to and part of the glass ribbon 103 and moving in the ribbon travel direction 154) to obtain a stress profile throughout the sample 401. The stress profile can comprise stress values at several locations within the sample 401, with peaks and valleys of stress. The stress profile can be obtained by obtaining a temperature profile of the sample 401. For example, a camera apparatus 407 can be positioned facing the sample 401, with the sample 401 passing through an optical field of view of the camera apparatus 407. The sample 401 can emit thermal light energy that can be received by the camera apparatus 407. The camera apparatus 407 can comprise, for example, an infrared camera that can detect infrared light and generate data based on the detected infrared light. Based on the infrared light and the data generated by the camera apparatus 407, a temperature at various locations of the sample 401 can be determined, wherein the temperature can be correlated to a stress. For example, a first temperature at a first location of the sample 401 can be correlated to a first stress, while a second temperature at a second location of the sample 401 can be correlated to a second stress.

Accordingly, the camera apparatus 407 can obtain a stress profile of the sample 401, with the stress profile comprising a plurality of stresses of the sample 401 at locations along a first axis 412, which is parallel to the first edge 403 and the second edge 405 and may be along the ribbon travel direction 154, and at locations along a second axis 413, which is perpendicular to the first edge 403 and the second edge 405 and may be perpendicular to the ribbon travel direction 154 and the first axis 412. The first edge 403 may be continuous with and extending coaxially with the first edge 153 of the glass ribbon 103 (e.g., illustrated in FIG. 1), and the second edge 405 may be continuous with and extending coaxially with the second edge 155 of the glass ribbon 103. In aspects, based on the stress profile, zero or more locations of the sample 401 can be determined to comprise stress regions outside of the predetermined stress range. For example, as illustrated in FIG. 4, the first region 411 can comprise a first stress that is outside (e.g., greater than or less than) the predetermined stress range. Determining the first location 409 can comprise measuring one or more of a first distance 415 between the first region 411 and the first edge 403 of the sample 401 or a second distance 417 between the first region 411 and the opposing second edge 405 of the sample 401. While FIG. 4 illustrates one region comprising a stress outside of the predetermined stress range, in aspects, the sample 401 may comprise additional regions with stresses outside of the predetermined stress range. Accordingly, the stress within the samples 301, 401, can be determined either by analyzing a separated portion of the glass ribbon 103, for example, the sample 301 in an off-line process, or by analyzing the sample 401 while the sample 401 is part of the glass ribbon 103, for example, in an on-line process.

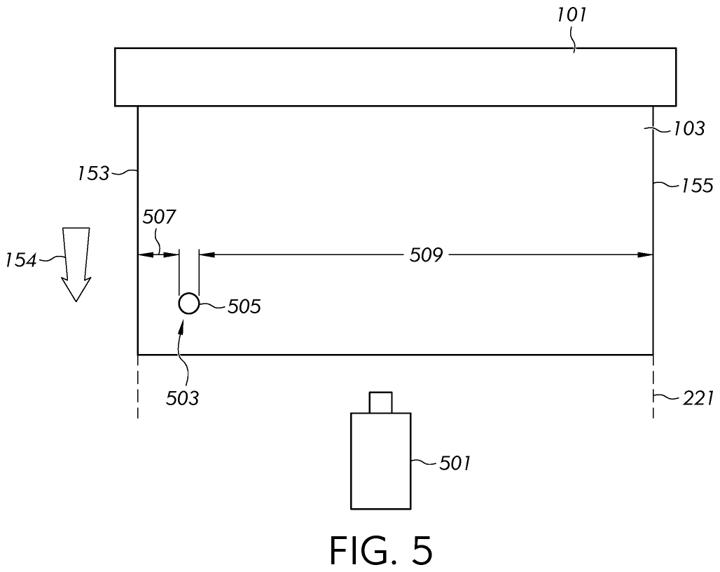

FIG. 5 illustrates a second camera apparatus 501 that can facilitate determining a location of a region comprising a stress outside of the predetermined stress range at an elevation of the glass ribbon 103 upstream from the samples 301, 401. For example, methods can comprise determining a second location 503 of a second region 505 from the glass ribbon 103 based on the first location 309, 409 from the sample 301, 401, with the second region 505 comprising a second stress outside of the predetermined stress range. In aspects, an operator can determine that the second region 505 comprises the second stress outside of the predetermined stress range due to the first regions 311, 411 comprising the first stress outside of the predetermined stress range and because the process parameters for manufacturing the glass ribbon 103 are the same for the samples 301, 401 comprising the first regions 311, 411 as for the glass ribbon 103 comprising the second region 505.

Determining the second location 503 can comprise locating one or more of a first distance 507 from the first edge 153 of the glass ribbon 103 or a second distance 509 from the opposing second edge 155 of the glass ribbon 103. The second camera apparatus 501 may be such that the glass ribbon 103 travels along the ribbon travel path 221 within a field of view of the second camera apparatus 501. A position of the first location 309 within the sample 301 (e.g., illustrated in FIG. 3) and/or a position of the first location 409 within the sample 401 (e.g., illustrated in FIG. 4) may already be determined and known. The first edge 153 can match the first edge 303, 403 of the sample 301, 401, and the second edge 155 can match the second edge 305, 405 of the sample 301, 401. As such, the first distance 315, 415 and/or the second distance 317, 417 determined from the sample 301, 401 can be applied to the glass ribbon 103 illustrated in FIG. 5. That is, the first distance 507 may be measured from the first edge 153 toward the second edge 155 and/or the second distance 509 may be measured from the second edge 155 toward the first edge 153. The first distance 507 can match the first distances 315, 415 of the sample 301, 401 and the second distance 509 can match the second distances 317, 417 of the sample 301, 401. The distances 507, 509 may be measured by an operator, or may be obtained via visual inspection by the second camera apparatus 501.

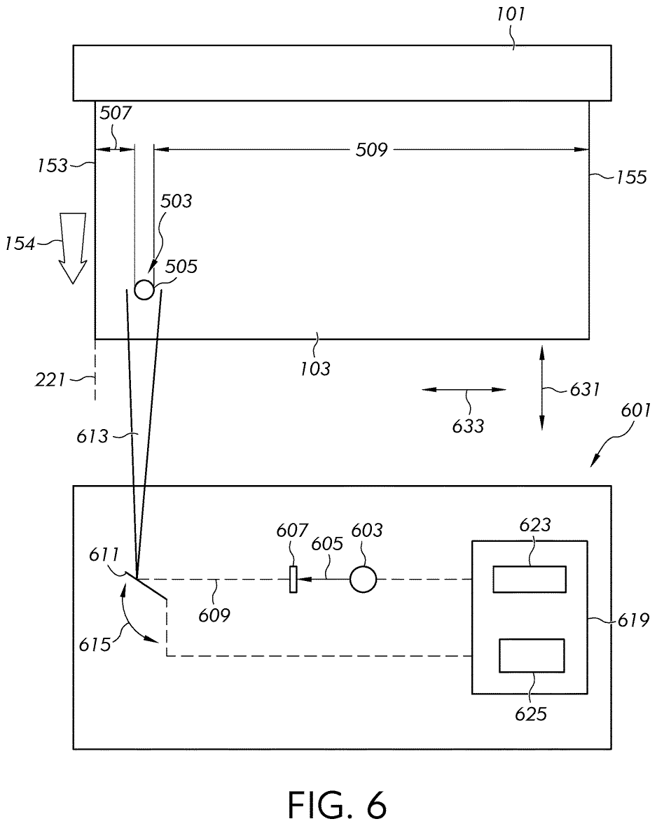

FIG. 6 illustrates a laser apparatus 601 comprising a laser source 603.

The laser source 603 can provide an initial laser beam 605 comprising a power and a wavelength. The laser apparatus 601 can comprise an optical lens 607 positioned within the path of the initial laser beam 605 such that the initial laser beam 605 may pass through the optical lens 607. In aspects, the optical lens 607 can comprise a cylindrical lens that can focus light passing through the optical lens 607 and transform the initial laser beam 605 into a focused laser beam 609. The laser apparatus 601 can comprise a mirror 611 positioned within the path of the focused laser beam 609 that can receive and deflect the focused laser beam 609, upon which a laser beam 613 is reflected from the mirror 611 toward the glass ribbon 103. The mirror 611 can be tiltable or rotatable (e.g., as indicated by arrow 615) around an axis in order to deflect the laser beam 613 to a desired location at the glass ribbon 103. In aspects, the laser beam 613 may be in the form of a single spot comprising a laser spot area that impinges upon the glass ribbon 103. The laser beam 613 can comprise, for example, a single point, a single point with a profiled laser power, and/or a scanning with an adjustable laser power profile. The mirror 611 may comprise, for example, a micro-electromechanical system (MEMS) scanning mirror. In aspects, the laser apparatus 6011 can comprise a CO₂ laser. Though not illustrated, the laser apparatus 601 can comprise additional components that function to deliver the laser beam 613, for example, optical lenses, diffractive optical elements, spatial light modulators, galvanometers, acoustic-optical beam deflectors, piezo-driven fast-scan mirrors, polygon scanners, etc. Further, the laser apparatus 601 can comprise an articulated arm that is movable based on a desired position of the laser beam 613 relative to the glass ribbon 103.

The laser apparatus 601 can comprise a control apparatus 619 that can control the laser beam 613, the mirror 611, etc. For example, the control apparatus 619 can comprise a processor 623 coupled with a memory 625. The processor 623 can be configured with executable instructions stored in the memory 625 to enable operations of the laser source 603, the mirror 611, etc. The processor 623 may be one of any form of general-purpose computer processors that can be used in an industrial setting for controlling various manufacturing equipment used in glass processing. The memory 625 may be in the form of a computer-readable medium and may be one or more of readily available memory such as random-access memory (RAM), read only memory (ROM), floppy disk, hard disk, or any other form of digital storage, local or remote. Support circuits (not shown) may be coupled to the processor 623 for supporting the processor in a conventional manner. These support circuits can include cache, power supplies, clock circuits, input/output circuitry and subsystems, and the like. The control apparatus 619 can control one or more of the power or the wavelength of the laser beam 613 to heat the glass ribbon 103 at a desired heating rate. Values for the laser power and wavelength can be stored and processed in the memory 625 and the processor 623. The laser source 601 can comprise a continuous wave laser or a pulsed laser. When the laser source 601 comprises a pulsed laser, the control apparatus 619 can control the pulse rate and/or the frequency of the pulsed laser, and the memory 625 and processor 623 can store and process values for the pulse rate and frequency.

In aspects, process routines for scanning the glass ribbon 103 with the laser beam 613 can be stored in the memory 625 as a software routine that, when executed by the processor 623, causes the laser apparatus 601 to perform processes disclosed herein. One or more components of the laser apparatus 601 can be moved with respect to the glass ribbon 103, though, the laser apparatus 601 can remain stationary while movement of the mirror 611 can cause the laser beam 613 to move relative to the glass ribbon 103. In aspects, the control apparatus 619 can calculate or convert vector data to movement information, which may be communicated to the mirror 611 to deflect the mirror in at least one plane (e.g., an X-Y plane, for example). While the laser apparatus 601 is illustrated as comprising one laser source, more than one laser source can be provided such that the laser apparatus 601 can produce a plurality of laser beams.

The laser apparatus 601 may be positioned downstream from the forming device 101 and, in aspects, may be positioned downstream from the second camera apparatus 501 of FIG. 5. The forming device 101 and the glass ribbon 103 may be positioned within a fusion machine bounded by one or more walls. The one or more walls can comprise one or more openings through which the laser beam 613 can pass to impinge upon the glass ribbon 103. A cross-sectional size of one of the one or more openings can be less than about 100 mm. A temperature within the fusion machine (e.g., within the environment within which the forming device 101 and the glass ribbon 103 are located) may be within a range from about 400° C. to about 900° C.

Methods can comprise heating the second region 505 (e.g., comprising a stress outside of the predetermined stress range) of the glass ribbon 103 by irradiating the second region 505 with the laser beam 613 while the glass ribbon 103 travels along the ribbon travel path 221 in the ribbon travel direction 154. As such, the second region 505 can be heated from a first temperature, which is greater than or equal to a transition temperature of the glass ribbon 103, to a second temperature. In aspects, a position of the laser beam 613 can be adjusted to reach the second location 503. For example, based on the first locations 309, 409 (e.g., illustrated in FIGS. 3-4), the second location 503 can be determined, for example, with the second location 503 located the first distance 507 from the first edge 153 and/or the second distance 509 from the second edge 155. Methods can comprise moving the laser beam 613 relative to the glass ribbon 103 in a first laser travel direction 631 along the ribbon travel path 221 in the ribbon travel direction 154. For example, the first laser travel direction 631 may be in a vertical direction substantially parallel to the first edge 153 and the second edge 155. In aspects, the laser beam 613 can irradiate the second region 505 by pulsing (e.g., on and off), for example, by being on for a period of time (e.g., one second to five seconds), followed by being off for a period of time (e.g., one second to five seconds), and repeating. In aspects, the laser beam 613 may continue to irradiate the portion of the glass ribbon 103 that is the first distance 507 from the first edge 153 and the second distance 509 from the second edge 509 as the glass ribbon 103 moves in the ribbon travel direction 154 such that the second region 505 and areas upstream and downstream from the second region 505 may be irradiated by the laser beam 613 (e.g., with the laser beam 613 maintained in a fixed position and the glass ribbon 103 moving relative to the laser beam 613).

In aspects, methods can comprise moving the laser beam 613 relative to the glass ribbon 103 in a second laser travel direction 633 across the ribbon travel path 221 perpendicular to the ribbon travel direction 154. For example, the second laser travel direction 633 may be in a horizontal direction substantially perpendicular to the first edge 153 and the second edge 155. The laser beam 613 can be moved in the first laser travel direction 631 and the second laser travel direction 633 in several ways, for example, by moving the laser apparatus 601 relative to the glass ribbon 103 and/or by adjusting the mirror 611 (e.g., by tilting 615) to move the laser beam 613. By moving the laser beam 613 relative to the glass ribbon 103, the laser beam 613 may reach the second location 503 and impinge upon the second region 505 to irradiate the second region 505. Accordingly, the laser beam 613 irradiate the second region 505 while not irradiating other areas of the glass ribbon 103. As such, areas of the glass ribbon 103 that comprise a stress within the predetermined stress range may not be irradiated by the laser beam 613 while areas of the glass ribbon 103 that comprise a stress outside the predetermined stress range (e.g., at the second location 503) may be irradiated by the laser beam 613.

In aspects, properties of the glass ribbon 103, for example, properties at the second location 503, can change due to the laser beam 613 irradiating the second region 505 while properties outside of or away from the second location 503 may not change due to the laser beam 613 not irradiating those areas. For example, the glass ribbon 103, during a cooling process, can undergo compaction (e.g., thermal stability or dimensional change), which is a dimensional change or shrinkage of the glass ribbon 103 due to changes in a fictive temperature of the glass ribbon 103. The fictive temperature is used to indicate a structural state of the glass ribbon 103, such that glass that is cooled quickly from a high temperature may comprise a higher fictive temperature due to a “frozen in” nature of the higher temperature structure, and glass that is cooled more slowly (e.g., annealed by holding for a time near an annealing point) can comprise a lower fictive temperature. In aspects, fluctuations of the fictive temperature of the glass ribbon 103 can result in residual stress, which, when measured with a polarized plane wave, can result in a glass retardance value (MRV). Reduction in fictive temperature fluctuations can reduce MRV. The glass ribbon 103 comprises a glass transition temperature (T_{g}) at which glass transition occurs. The glass transition is the gradual and reversible transition in amorphous materials from hard and relatively brittle “glassy” state to a viscous or rubbery state as the temperature is increased. At a temperature below the glass transition temperature, the molecular chains of the amorphous materials are frozen in place and behave like solid glass. For example, the glass ribbon 103 can comprise a glass transition temperature (T_{g}) within a range from about 620° C. to about 780° C., and a viscosity range at the glass transition temperature (T_{g}) may be within a range from about 10⁶ poise to about 10¹² poise.

In aspects, the second region 505 comprises a first viscosity prior to heating with the laser beam 613 and a second viscosity after heating with the laser beam 613. In aspects, the first viscosity is different than the second viscosity, with the difference between the first viscosity and the second viscosity being less than about 1×10¹² poise. For example, the laser apparatus 601 may be positioned relative to the glass ribbon 103 such that the laser beam 613 irradiates the glass ribbon 103 upstream from the separator 149 and while the glass ribbon 103 is at the first temperature, which may be greater than or equal to a transition temperature of the glass ribbon 103. In aspects, the second region 505 comprises a first temperature prior to heating with the laser beam 613 and a second temperature after heating with the laser beam 613. The first temperature may be different than the second temperature, with the difference between the first temperature and the second temperature being less than about 10° C. In aspects, the second region 505 comprises a first fictive temperature prior to heating with the laser beam 613 and a second fictive temperature after heating with the laser beam 613. In aspects, the first fictive temperature may be different than the second fictive temperature, with the second fictive temperature less than the first fictive temperature. For example, in aspects, the glass ribbon 103 may initially have a first fictive temperature, but, upon heating, the fictive temperature may increase, while lagging the temperature of the glass ribbon 103. As the glass ribbon 103 is cooled, the fictive temperature may decrease, again lagging the temperature of the glass ribbon 103. As the glass ribbon 103 reaches a temperature at which the glass ribbon 103 cannot be accommodated, the fictive temperature may stabilize. In aspects, the fictive temperature of the glass ribbon 103 may initially increase (e.g., to be greater than the first fictive temperature) upon heating, and may reach the second fictive temperature upon cooling of the glass ribbon 103. The laser beam 613 can irradiate portions of the glass ribbon 103 as the glass ribbon 103 is at an elevated temperature and moving along the ribbon travel direction 154. As such, a reduced laser power of the laser beam 613 is required to heat the glass ribbon 103 to the desired second temperature as compared to if the laser beam 613 heated the glass ribbon 103 from room temperature to the second temperature.

In aspects, methods can comprise cooling the second region 505 from the second temperature such that the second region 505 comprises a third stress within the predetermined stress range. The third stress may be different than the second stress, with the second stress outside of the predetermined stress range and the third stress within the predetermined stress range. In aspects, heating the second region 505 can comprise setting a wavelength of the laser beam 613 irradiating the second region 505 based on a difference between the second stress and the third stress. For example, heating the second region can comprise setting a power of the laser beam 613 irradiating the second region 505 based on a difference between the second stress and the third stress. In this way, the power and wavelength of the laser beam 613 can be determined based on the stress (e.g., outside of the predetermined stress range) of the sample 301, 401, and a stress within the predetermined stress range, and the temperature to which the second region 505 must be heated to obtain the desired stress upon cooling. The power and wavelength of the laser beam 613 may be set as follows. Initially, a region of stress that is outside of the predetermined stress range can be determined, and the laser beam 613 (at a first power and first wavelength) can irradiate the region of stress. An operator may analyze and inspect the glass ribbon after cooling to determine if the first power and the first wavelength were sufficient to change the region of stress to a stress that is within the predetermined stress range. If the region of stress is within the predetermined stress range, then the laser beam 613 may continue to be operated at the first power and first wavelength. If the region of stress is still outside the predetermined stress range, then one or more of the power or the wavelength of the laser beam 613 may be adjusted and the process can repeat. As such, in aspects, an iterative and empirical process comprising a feedback loop may be used to correlate the power and wavelength of the laser beam 613 to the desired change in stress of the glass ribbon 103. In aspects, the wavelength of the laser beam 613 may be maintained as constant while the power of the laser beam 613 can be adjusted. In addition, or in the alternative, other properties of the laser beam 613 can also be adjusted, such as, for example, a dimension and/or beam shape of the laser beam.

While some properties of the glass ribbon 103 may change, for example, the stress, fictive temperature, etc., due to the laser beam 613 impinging upon portions of the glass ribbon 103, a thickness of the glass ribbon 103 does not change. For example, despite the laser beam 613 irradiating the second location 503, a thickness of the glass ribbon 103 at the second location 503 may substantially match a thickness of the glass ribbon 103 at other portions of the glass ribbon 103 outside of and away from the second location 503. In this way, the laser beam 613 may not impact or change the thickness of the glass ribbon 103.

It should be understood that while various aspects have been described in detail relative to certain illustrative and specific examples thereof, the present disclosure should not be considered limited to such, as numerous modifications and combinations of the disclosed features are possible without departing from the scope of the following claims.

1. A method of manufacturing glass comprising:
determining a first location of a first region from a sample of a glass ribbon, the first region comprising a first stress outside of a predetermined stress range;
determining a second location of a second region from the glass ribbon based on the first location from the sample, the second region comprising a second stress outside of the predetermined stress range;
heating the second region of the glass ribbon by irradiating the second region with a laser beam while the glass ribbon travels along a ribbon travel path in a ribbon travel direction such that the second region is heated from a first temperature, which is greater than or equal to a transition temperature of the glass ribbon, to a second temperature; and
cooling the second region from the second temperature such that the second region comprises a third stress within the predetermined stress range.

2. The method of claim 1, wherein the second region comprises a first viscosity prior to heating with the laser beam and a second viscosity after heating with the laser beam, and a difference between the first viscosity and the second viscosity is less than 1×10¹² poise.

3. The method of claim 1, wherein a difference between the first temperature and the second temperature is less than 10° C.

4. The method of claim 1, wherein the second region comprises a first fictive temperature prior to heating with the laser beam and a second fictive temperature after heating with the laser beam, the second fictive temperature different than the first fictive temperature.

5. The method of claim 1, wherein the determining the first location comprises measuring one or more of a first distance between the first region and a first edge of the sample or a second distance between the first region and an opposing second edge of the sample.

6. The method of claim 5, wherein the determining the second location comprises locating one or more of the first distance from the first edge of the glass ribbon or the second distance from the opposing second edge of the glass ribbon.

7. The method of claim 5, wherein the heating the second region comprises setting a wavelength of the laser beam irradiating the second region based on a difference between the second stress and the third stress.

8. The method of claim 5, wherein the heating the second region comprises setting a power of the laser beam irradiating the second region based on a difference between the second stress and the third stress.

9. The method of claim 1, further comprising moving the laser beam relative to the glass ribbon in a first laser travel direction along the ribbon travel path in the ribbon travel direction.

10. The method of claim 1, further comprising moving the laser beam relative to the glass ribbon in a second laser travel direction across the ribbon travel path perpendicular to the ribbon travel direction.

11. A method of manufacturing glass comprising:
heating a region of a glass ribbon comprising a first stress outside of a predetermined stress range by irradiating the region with a laser beam as the glass ribbon moves along a ribbon travel path in a ribbon travel direction such that the region is heated from a first temperature greater than or equal to a transition temperature of the glass ribbon to a second temperature, the region comprising a first viscosity prior to heating with the laser beam and a second viscosity after heating with the laser beam such that a difference between the first viscosity and the second viscosity is less than 1×10¹² poise and a difference between the first temperature and the second temperature is less than 10° C.; and
cooling the region from the second temperature such that the region comprises a second stress within the predetermined stress range.

12. The method of claim 11, wherein the region comprises a first fictive temperature prior to heating with the laser beam and a second fictive temperature after heating with the laser beam, the second fictive temperature different than the first fictive temperature.

13. The method of claim 11, wherein the heating the region comprises setting a wavelength of the laser beam irradiating the region based on a difference between the first stress and the second stress.

14. The method of claim 11, wherein the heating the region comprises setting a power of the laser beam irradiating the region based on a difference between the first stress and the second stress.

15. The method of claim 11, further comprising moving the laser beam relative to the glass ribbon in a first laser travel direction along the ribbon travel path in the ribbon travel direction.

16. The method of claim 11, further comprising moving the laser beam relative to the glass ribbon in a second laser travel direction across the ribbon travel path perpendicular to the ribbon travel direction.

17. The method of claim 11, further comprising determining a first location of a first region from a sample of the glass ribbon, the first region comprising the first stress outside of the predetermined stress range, the determining the first location comprising measuring one or more of a first distance between the first region and a first edge of the sample or a second distance between the first region and an opposing second edge of the sample.

18. The method of claim 17, wherein, prior to heating the region, further comprising determining a location of the region based on the first location from the sample.
